(19) United States
(12) Patent Application Publication
(10) Pub. No.: US 2026/0097318 A1
(43) Pub. Date: Apr. 9, 2026

(54) RACING SIMULATION USING ACTIVE SEATBELT TENSIONER

(71) Applicant: Lenovo (United States) Inc., Morrisville, NC (US)

(72) Inventors: James LaCroix, Morrisville, NC (US); Axel Ramirez, Morrisville, NC (US); Nicolas Allebrodt, Morrisville, NC (US)

(21) Appl. No.: 18/908,544

(22) Filed: Oct. 7, 2024

(51) Int. Cl. A63F 13/803; A63F 13/285

(52) U.S. Cl. CPC A63F 13/803; A63F 13/285

(57) ABSTRACT

In one aspect, a device includes a processor system and storage accessible to the processor system. The storage includes instructions executable by the processor system to facilitate a racing simulation. The instructions are also executable to, as part of facilitating the racing simulation, control a seatbelt tensioner in real time as the racing simulation transpires. The seatbelt tensioner is controlled in real time based on one or more variable inputs associated with the racing simulation, such as virtual vehicle drifting, virtual vehicle braking, or virtual vehicle turning.

### FIELD

The disclosure below relates to technically inventive, non-routine solutions that are necessarily rooted in computer technology and that produce concrete technical improvements. In particular, the disclosure below relates to improved racing simulations using an active seatbelt tensioner.

### BACKGROUND

As recognized herein, current input and output modalities related to computer simulations are limited and can be improved.

### SUMMARY

Accordingly, in one aspect a device includes a processor system and storage accessible to the processor system. The storage includes instructions executable by the processor system to facilitate a racing simulation. The instructions are also executable to, as part of facilitating the racing simulation, control a seatbelt tensioner in real time as the racing simulation transpires. The seatbelt tensioner is controlled in real time based on one or more variable inputs associated with the racing simulation.

In one specific example implementation, the seatbelt tensioner may include a five-point seatbelt tensioner, with the seatbelt tensioner couplable to a seat of an electronic race car at five different points on the seat. The seatbelt tensioner may be another type of seatbelt tensioner as well, such as a two-point or three-point seatbelt tensioner. What’s more, in some examples, the device itself may include the seatbelt tensioner, the seat, and/or the electronic race car.

Also in one example embodiment, the instructions may be executable to, as part of facilitating the racing simulation, control the seatbelt tensioner to tighten a first strap of the seatbelt tensioner a first amount and to concurrently tighten a second strap of the seatbelt tensioner a second amount, with the first strap being different from the second strap. The first amount may be the same as or different from the second amount.

Additionally, in some examples the instructions may be executable to execute a model to receive the one or more variable inputs and to generate, based on the one or more variable inputs, an inference indicating the first amount and the second amount. In various examples, variable inputs may relate to virtual vehicle drifting in the racing simulation, to virtual vehicle braking in the racing simulation, to a virtual vehicle collision in the racing simulation, and/or to virtual vehicle traction loss in the racing simulation due to virtual inclement weather.

Furthermore, in certain implementations, the one or more variable inputs may be provided by a simulation engine that executes the racing simulation.

In another aspect, a method includes facilitating a racing simulation. The method also includes, as part of facilitating the racing simulation, dynamically controlling a seatbelt tensioner as the racing simulation transpires. The seatbelt tensioner is dynamically controlled based on one or more variable inputs associated with the racing simulation.

In one specific example, the method may include dynamically controlling the seatbelt tensioner by reducing tension in one or more straps of the seatbelt tensioner responsive to virtual vehicle braking in the racing simulation. Also in some examples, the method may include dynamically controlling the seatbelt tensioner by increasing tension in one or more straps of the seatbelt tensioner responsive to virtual vehicle acceleration in the racing simulation.

Still further, if desired the method may include executing a model to receive the one or more variable inputs and to generate, based on the one or more variable inputs, an inference indicating a configuration of the seatbelt tensioner to apply in response to an event in the racing simulation.

In still another aspect, at least one computer readable storage medium (CRSM) that is not a transitory signal includes instructions executable by a processor system to facilitate a racing simulation. The instructions are also executable to, as part of facilitating the racing simulation, control a seatbelt tensioner in real time as the racing simulation transpires. The seatbelt tensioner is controlled in real time based on one or more inputs associated with the racing simulation.

In some non-limiting examples, the instructions may be executable to execute a model to receive the one or more inputs and to generate, based on the one or more inputs, an inference indicating a configuration of the seatbelt tensioner to apply in response to an event in the racing simulation. Also in non-limiting examples, the model may be an artificial intelligence (AI) model.

Additionally, in some cases the configuration of the seatbelt tensioner may include a left-side strap of the seatbelt tensioner being shorter than a right-side strap of the seatbelt tensioner.

The details of present principles, both as to their structure and operation, can best be understood in reference to the accompanying drawings, in which like reference numerals refer to like parts, and in which:

### BRIEF DESCRIPTION OF THE DRAWINGS

FIG. 1 is a block diagram of an example system consistent with present principles;

FIG. 2 is a block diagram of an example network of devices consistent with present principles;

FIG. 3 is a block diagram of an example extended reality (XR) headset consistent with present principles;

FIG. 4 is a perspective view illustration of an example electronic racecar in which a user can sit while playing a racing simulation consistent with present principles;

FIG. 5 shows example logic in example flow chart format that may be executed during a racing simulation to apply tension to a driver using an active seatbelt tensioner consistent with present principles;

FIG. 6 shows example logic in example flow chart format that may be used to configure a machine learning (ML) model consistent with present principles;

FIG. 7 shows example software architecture that may be implemented consistent with present principles; and

FIG. 8 shows an example graphical user interface (GUI) that may be presented to configure one or more settings of a device, app, and/or hardware race car simulator to operate consistent with present principles.

### DETAILED DESCRIPTION

Among other things, the detailed description below describes devices and methods that connect racer biometrics and sensor data to provide a next generation AR/VR racing simulation experience. Thus, a cutting-edge, no-latency AR/VR racing simulation experience is provided with the use of sensors fused with racer biometrics data using artificial intelligence and/or deep learning. In one specific example, a convolutional neural network (CNN) and deep learning algorithm/deep learning approach may be used for multimodal biometric and sensor recognition.

Sensors that may be involved include vitals biometric sensor(s) on the wrist, camera(s) for eye tracking inside the virtual headset, and microphones for voice control.

The user may thus feel every turn with the active seatbelt tensioner, providing unparalleled realism to the user’s racing experience.

Motion controls may also be used, with a tactical and haptic feedback system fused with racer biometrics data using AI/deep learning.

Additionally, race control real-time telemetry may be fused with racer biometrics data, voice commands, and eye positioning. Human real-time vitals monitoring may be used consistent with present principles (e.g., heart rate, oxygen levels, pupil dilation, body temperature).

As mentioned above, use cases include not just gaming but training, educational (e.g., totally virtual), deliveries, simulations of real life activities, etc. (part real life, part virtual).

Therefore, in one particular aspect, a five-point active seat belt tensioner system with intelligent software for sim racing may be used to actively adjust the tension of the car’s seat belt straps to simulate real-world g-forces and vehicle dynamics. This in turn enhances the tactile feedback and realism of the racing simulation.

Thus, the system can mimic the tightening sensation when the vehicle accelerates and the slack during sudden vehicle stops.

Additionally, AI support for enhanced feedback may be used, where AI algorithms analyze data from the simulation regarding vehicle speed, vehicle cornering, and other dynamics to adjust the belt tension appropriately. In non-limiting instances, this integration may help ensure that the physical feedback from the seat belt is both timely and accurate, enhancing the training and entertainment value of the race.

In one specific example, the tensioner system may communicate with the racing simulation software, enabling it to receive real-time data about the virtual track, virtual car performance, and driver virtual actions, synchronizing strap movement with the visuals and inputs.

One example use case includes enhanced immersive experiences in sim racing, providing a realistic sensation of g-forces through the seat belts and improving the authenticity of the driving simulation while helping racers feel more connected to the car and the environment. Additionally, the tension adjustments may allow racers to experience a physical force of their actions, such as feeling the tug of the belt during a high-speed turn or the loosening of the belt during sudden deceleration.

If desired, customizable simulation settings may be provided for various racing scenarios. For example, racers can adjust the intensity and responsiveness of the belt tension to match different types of vehicles and racing conditions, tailoring the simulation to their needs or vehicle preferences. As another example, the system can recreate the specific belt tension profiles of different racing cars, ranging from street cars to formula race cars, providing a versatile tool for a wide range of sim racers.

The example five-point active seat belt tensioner system can therefore enhance the realism and experience of sim racing by providing dynamic, context-sensitive tactile feedback, making the simulation as close to real driving as possible through the technical improvements advanced herein.

Prior to delving further into the details of the instant techniques, note with respect to any computer systems discussed herein that a system may include server and client components, connected over a network such that data may be exchanged between the client and server components. The client components may include one or more computing devices including televisions (e.g., smart TVs, Internet-enabled TVs), computers such as desktops, laptops and tablet computers, so-called convertible devices (e.g., having a tablet configuration and laptop configuration), and other mobile devices including smart phones. These client devices may employ, as non-limiting examples, operating systems from Apple Inc. of Cupertino CA, Google Inc. of Mountain View, CA, or Microsoft Corp. of Redmond, WA. A Unix® or similar such as Linux® operating system may be used, as may a Chrome or Android or Windows or macOS or iOS operating system. These operating systems can execute one or more browsers such as a browser made by Microsoft or Google or Mozilla or another browser program that can access web pages and applications hosted by Internet servers over a network such as the Internet, a local intranet, or a virtual private network.

As used herein, instructions refer to computer-implemented steps for processing information in the system. Instructions can be implemented in software, firmware or hardware, or combinations thereof and include any type of programmed step undertaken by components of the system; hence, illustrative components, blocks, modules, circuits, and steps are sometimes set forth in terms of their functionality.

A processor may be any single- or multi-chip processor that can execute logic by means of various lines such as address lines, data lines, and control lines and registers and shift registers. Moreover, any logical blocks, modules, and circuits described herein can be implemented or performed with a system processor such as a central processing unit (CPU), a graphics processing unit (GPU), a neural processing unit (NPU), a digital signal processor (DSP), a field programmable gate array (FPGA) or other programmable logic device such as an application specific integrated circuit (ASIC), discrete gate or transistor logic, discrete hardware components, or any combination thereof designed to perform the functions described herein. A processor can also be implemented by a controller or state machine or a combination of computing devices. Thus, the methods herein may be implemented as software instructions executed by a processor, suitably configured application specific integrated circuits (ASIC) or field programmable gate array (FPGA) modules, or any other convenient manner as would be appreciated by those skilled in the art. Where employed, the software instructions may also be embodied in a non-transitory device that is being vended and/or provided, and that is not a transitory, propagating signal and/or a signal per se. For instance, the non-transitory device may be or include a hard disk drive, solid state drive, or CD ROM. Flash drives may also be used for storing the instructions. Additionally, the software code instructions may also be downloaded over the Internet (e.g., as part of an application (“app”) or software file). Accordingly, it is to be understood that although a software application for undertaking present principles may be vended with a device such as the system 100 described below, such an application may also be downloaded from a server to a device over a network such as the Internet. An application can also run on a server and associated presentations may be displayed through a browser (and/or through a dedicated companion app) on a client device in communication with the server.

Software modules and/or applications described by way of flow charts and/or user interfaces herein can include various sub-routines, procedures, etc. Without limiting the disclosure, logic stated to be executed by a particular module can be redistributed to other software modules and/or combined together in a single module and/ or made available in a shareable library. Also, the user interfaces (UI)/graphical UIs described herein may be consolidated and/or expanded, and UI elements may be mixed and matched between UIs.

Logic when implemented in software, can be written in an appropriate language such as but not limited to hypertext markup language (HTML)-5, Java^{®}/JavaScript, C# or C++, and can be stored on or transmitted from a computer-readable storage medium such as a hard disk drive (HDD) or solid state drive (SSD), a random access memory (RAM), read-only memory (ROM), electrically erasable programmable read-only memory (EEPROM), a hard disk drive or solid state drive, compact disk read-only memory (CD-ROM) or other optical disk storage such as digital versatile disc (DVD), magnetic disk storage or other magnetic storage devices including removable thumb drives, etc.

In an example, a processor can access information over its input lines from data storage, such as the computer readable storage medium, and/or the processor can access information wirelessly from an Internet server by activating a wireless transceiver to send and receive data. Data typically is converted from analog signals to digital by circuitry between the antenna and the registers of the processor when being received and from digital to analog when being transmitted. The processor then processes the data through its shift registers to output calculated data on output lines, for presentation of the calculated data on the device.

Components included in one embodiment can be used in other embodiments in any appropriate combination. For example, any of the various components described herein and/or depicted in the Figures may be combined, interchanged or excluded from other embodiments.

The term “a” or “an” in reference to an entity refers to one or more of that entity. As such, the terms “a” or “an”, “one or more”, and “at least one” can be used interchangeably herein.

"A system having at least one of A, B, and C" (likewise "a system having at least one of A, B, or C" and "a system having at least one of A, B, C") includes systems that have A alone, B alone, C alone, A and B together, A and C together, B and C together, and/or A, B, and C together, etc.

The term “circuit” or “circuitry” may be used in the summary, description, and/or claims. The term “circuitry” includes all levels of available integration, e.g., from discrete logic circuits to the highest level of circuit integration such as VLSI, and includes programmable logic components programmed to perform the functions of an embodiment as well as processors (e.g., special-purpose processors) programmed with instructions to perform those functions.

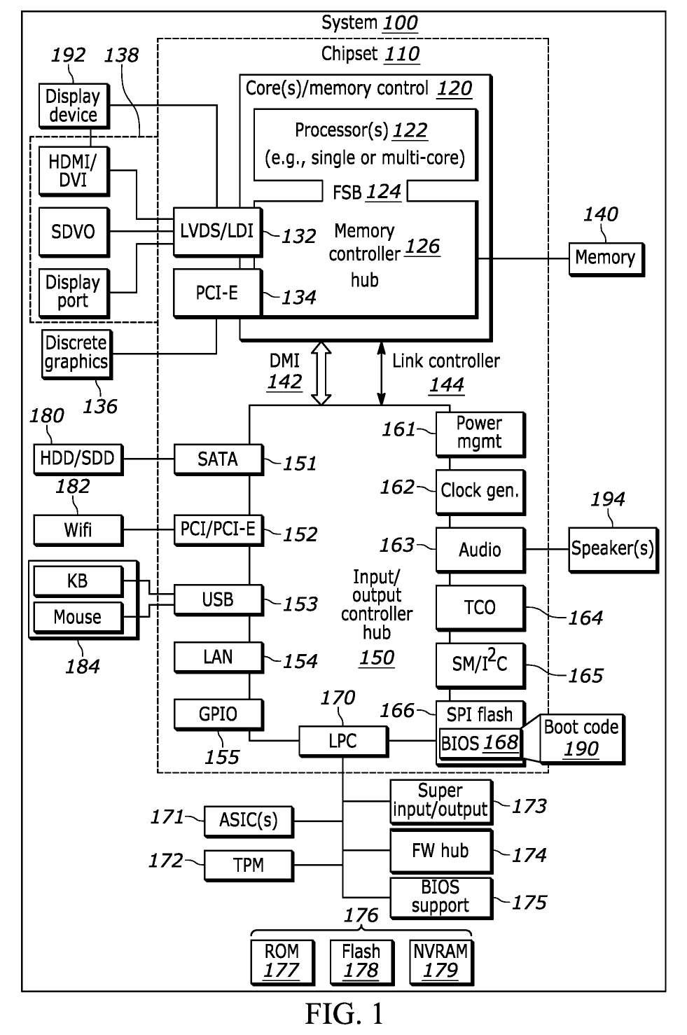

Now specifically in reference to FIG. 1, an example block diagram of an information handling system and/or computer system 100 is shown that is understood to have a housing for the components described below. Note that in some embodiments the system 100 may be a desktop computer system, such as one of the ThinkCentre®, or notebook computer system, such as ThinkPad® series of personal computers sold by Lenovo (US) Inc. of Morrisville, NC, or a workstation computer, such as the ThinkStation®, which are sold by Lenovo (US) Inc. of Morrisville, NC; however, as apparent from the description herein, a client device, a server or other machine in accordance with present principles may include other features or only some of the features of the system 100. Also, the system 100 may be, e.g., a game console such as XBOX®, and/or the system 100 may include a mobile communication device such as a mobile telephone, notebook computer, and/or other portable computerized device.

As shown in FIG. 1, the system 100 may include a so-called chipset 110. A chipset refers to a group of integrated circuits, or chips, that are designed to work together. Chipsets are usually marketed as a single product (e.g., consider chipsets marketed under the brands INTEL®, AMD®, etc.).

In the example of FIG. 1, the chipset 110 has a particular architecture, which may vary to some extent depending on brand or manufacturer. The architecture of the chipset 110 includes a core and memory control group 120 and an I/O controller hub 150 that exchange information (e.g., data, signals, commands, etc.) via, for example, a direct management interface or direct media interface (DMI) 142 or a link controller 144. In the example of FIG. 1, the DMI 142 is a chip-to-chip interface (sometimes referred to as being a link between a “northbridge” and a “southbridge”).

The core and memory control group 120 includes a processor system 122 (e.g., one or more single core or multi-core processors, etc.) and a memory controller hub 126 that exchange information via a front side bus (FSB) 124. A processor system such as the system 122 may therefore include one or more processors acting independently or in concert with each other to execute an algorithm, whether those processors are in one device or more than one device. Additionally, as described herein, various components of the core and memory control group 120 may be integrated onto a single processor die, for example, to make a chip that supplants the “northbridge” style architecture.

The memory controller hub 126 interfaces with memory 140. For example, the memory controller hub 126 may provide support for DDR SDRAM memory (e.g., DDR, DDR2, DDR3, etc.). In general, the memory 140 is a type of random-access memory (RAM). It is often referred to as “system memory.”

The memory controller hub 126 can further include a low-voltage differential signaling interface (LVDS) 132. The LVDS 132 may be a so-called LVDS Display Interface (LDI) for support of a display device 192 (e.g., a CRT, a flat panel, a projector, a touch-enabled light emitting diode (LED) display or other video display, etc.). A block 138 includes some examples of technologies that may be supported via the LVDS interface 132 (e.g., serial digital video, HDMI/DVI, display port). The memory controller hub 126 also includes one or more PCI-express interfaces (PCI-E) 134, for example, for support of discrete graphics 136. For example, the memory controller hub 126 may include a 16-lane (x16) PCI-E port for an external PCI-E-based graphics card (including, e.g., one or more GPUs). An example system may thus include PCI-E for support of graphics.

In examples in which it is used, the I/O hub controller 150 can include a variety of interfaces. The example of FIG. 1 includes a SATA interface 151, one or more PCI-E interfaces 152 (optionally one or more legacy PCI interfaces), one or more universal serial bus (USB) interfaces 153, a local area network (LAN) interface 154 (more generally a network interface for communication over at least one network such as the Internet, a WAN, a LAN, a Bluetooth network using Bluetooth 5.0 communication, etc. under direction of the processor(s) 122), a general purpose I/O interface (GPIO) 155, a low-pin count (LPC) interface 170, a power management interface 161, a clock generator interface 162, an audio interface 163 (e.g., for speakers 194 to output audio), a total cost of operation (TCO) interface 164, a system management bus interface (e.g., a multi-master serial computer bus interface) 165, and a serial peripheral flash memory/controller interface (SPI Flash) 166, which, in the example of FIG. 1, includes basic input/output system (BIOS) 168 and boot code 190. With respect to network connections, the I/O hub controller 150 may include integrated gigabit Ethernet controller lines multiplexed with a PCI-E interface port. Other network features may operate independent of a PCI-E interface. Example network connections include Wi-Fi as well as wide-area networks (WANs) such as 4G and 5G cellular networks.

The interfaces of the I/O hub controller 150 may provide for communication with various devices, networks, etc. For example, where used, the SATA interface 151 and/or PCI-E interface 152 provide for reading, writing or reading and writing information on one or more drives 180 such as HDDs, SSDs or a combination thereof, but in any case the drives 180 are understood to be, e.g., tangible computer readable storage mediums that are not transitory, propagating signals. The I/O hub controller 150 may also include an advanced host controller interface (AHCI) to support one or more drives 180. The PCI-E interface 152 allows for wireless connections 182 to devices, networks, etc. The USB interface 153 provides for input devices 184 such as keyboards (KB), mice and various other devices (e.g., cameras, phones, storage, media players, etc.).

In the example of FIG. 1, the LPC interface 170 provides for use of one or more ASICs 171, a trusted platform module (TPM) 172, a super I/O 173, a firmware hub 174, BIOS support 175 as well as various types of memory 176 such as ROM 177, Flash 178, and non-volatile RAM (NVRAM) 179. With respect to the TPM 172, this module may be in the form of a chip that can be used to authenticate software and hardware devices. For example, a TPM may be capable of performing platform authentication and may be used to verify that a system seeking access is the expected system.

The system 100, upon power on, may be configured to execute boot code 190 for the BIOS 168, as stored within the SPI Flash 166, and thereafter processes data under the control of one or more operating systems and application software (e.g., stored in system memory 140). An operating system may be stored in any of a variety of locations and accessed, for example, according to instructions of the BIOS 168.

Additionally, though not shown for simplicity, in some embodiments the system 100 may include a gyroscope that senses and/or measures the orientation of the system 100 and provides related input to the processor system 122, an accelerometer that senses acceleration and/or movement of the system 100 and provides related input to the processor system 122, and/or a magnetometer that senses and/or measures directional movement of the system 100 and provides related input to the processor system 122.

Still further, the system 100 may include an audio receiver/microphone that provides input from the microphone to the processor system 122 based on audio that is detected, such as via a user providing audible input to the microphone. The system 100 may also include a camera that gathers one or more images and provides the images and related input (e.g., metadata like an image timestamp) to the processor system 122. The camera may be a thermal imaging camera, an infrared (IR) camera, a digital camera such as a webcam, a three-dimensional (3D) camera, and/or a camera otherwise integrated into the system 100 and controllable by the processor system 122 to gather still images and/or video.

Also, the system 100 may include a global positioning system (GPS) transceiver that is configured to communicate with satellites to receive/identify geographic position information and provide the geographic position information to the processor system 122. However, it is to be understood that another suitable position receiver other than a GPS receiver may be used in accordance with present principles to determine the location of the system 100.

It is to be understood that an example client device or other machine/computer may include fewer or more features than shown on the system 100 of FIG. 1. In any case, it is to be understood at least based on the foregoing that the system 100 is configured to undertake present principles.

Present principles may employ various machine learning models, including deep learning models. Machine learning models consistent with present principles may use various algorithms trained in ways that include supervised learning, unsupervised learning, semi-supervised learning, reinforcement learning, feature learning, self-learning, and other forms of learning. Examples of such algorithms, which can be implemented by computer circuitry, include one or more neural networks, such as a convolutional neural network (CNN), a recurrent neural network (RNN), and a type of RNN known as a long short-term memory (LSTM) network. Generative pre-trained transformers (GPTT) also may be used. Support vector machines (SVM) and Bayesian networks also may be considered to be examples of machine learning models. In addition to the types of networks set forth above, models herein may be implemented by classifiers.

As understood herein, performing machine learning may therefore involve accessing and then training a model on training data to enable the model to process further data to make inferences. An artificial neural network trained through machine learning may thus include an input layer, an output layer, and multiple hidden layers in between that are configured and weighted to make inferences about an appropriate output.

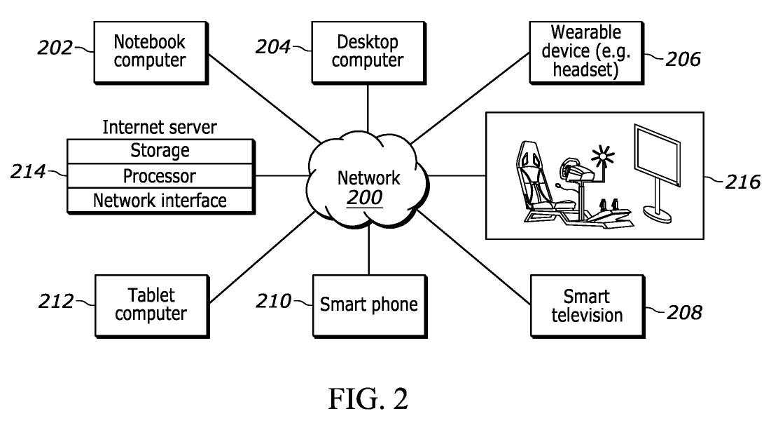

Turning now to FIG. 2, example devices are shown communicating over a network 200 such as the Internet in accordance with present principles. It is to be understood that each of the devices described in reference to FIG. 2 may include at least some of the features, components, and/or elements of the system 100 described above. Indeed, any of the devices disclosed herein may include at least some of the features, components, and/or elements of the system 100 described above.

FIG. 2 shows a notebook computer and/or convertible computer 202, a desktop computer 204, a wearable device 206 such as a smart watch or XR headset, a smart television (TV) 208, a smart phone 210, a tablet computer 212, an electronic race car 216 in which a user can sit while playing a racing simulation, and a server 214 such as an Internet server that may provide cloud storage accessible to the devices 202-212, 216. It is to be understood that the devices 202-216 may be configured to communicate with each other over the network 200 to undertake present principles.

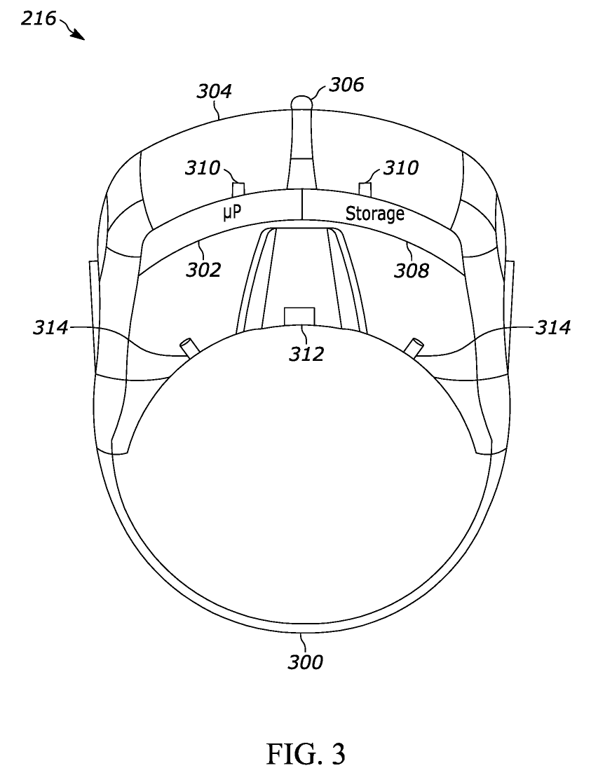

Now describing FIG. 3, it shows a top plan view of a headset such as the headset 206 consistent with present principles. The headset 206 may be used to present audio and/or video of the racing simulation at the headset’s speakers and display while other input/output is provided via the electronic race car 216.

The headset 206 may include a housing 300, at least one processor assembly 302 in the housing 300, and a non-transparent or transparent “heads up” display 304 accessible to the at least one processor assembly 302 and coupled to the housing 300. The display 304 may for example have discrete left and right eye pieces as shown for presentation of stereoscopic images and/or 3D virtual images/objects using augmented reality (AR) software, virtual reality (VR) software, and/or mixed reality (MR) software (more generally, extended reality (XR) software). The display 304 may thus present visual content related to the racing simulation.

The headset 206 may also include one or more forward-facing cameras 306. As shown, the camera 306 may be mounted on a bridge portion of the display 304 above where the user’s nose would be so that it may have an outward-facing field of view similar to that of the user himself or herself while wearing the headset 206. The camera 306 may be used for computer vision, image registration, spatial mapping, etc. to identify biometrics and other data as described herein and/or to track user movements within real-world space. However, further note that the camera(s) 306 may be located at other headset locations as well. Further note that in some examples, inward-facing cameras 310 may also be mounted within the headset 206 and oriented to image the user’s eyes for eye tracking while the user wears the headset 206 consistent with present principles.

Additionally, the headset 206 may include storage 308 accessible to the processor assembly 302 and coupled to the housing 300, a microphone 312 for detecting audio of the user speaking to provide voice commands to the racing simulation and detecting audio biometric data consistent with present principles (e.g., detecting excitement in the user’s voice). The headset 206 may include additional biometric sensors 314 as well, such as a heart rate sensor, an oxygen level sensor, and/or a body temperature sensor.

The headset 206 may include still other components not shown for simplicity, such as a network interface for communicating over a network such as the Internet and a battery for powering components of the headset 206 such as the camera(s) 306. The headset 206 may also include one or more speakers for presenting audio of the racing simulation. Additionally, note that while the headset 206 is illustrated as a head-circumscribing VR headset, it may also be established by computerized smart glasses or another type of headset including other types of AR and MR headsets. For example, the headset may be established by an AR headset that may have a transparent display that is able to present 3D virtual objects/content.

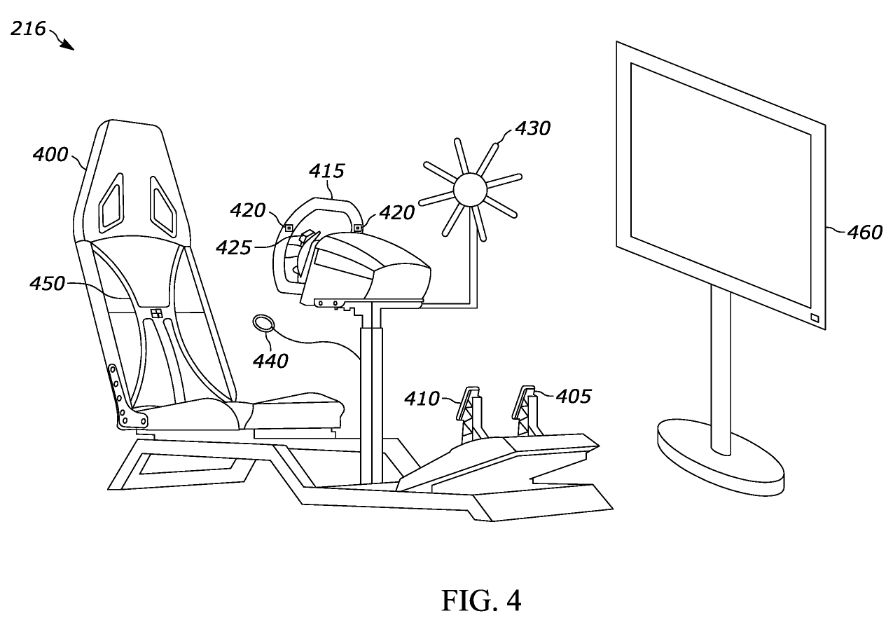

As mentioned above, the headset 206 may also communicate with the electronic race car 216 and/or a remotely-located server such as the server 214 to execute/facilitate a racing simulation consistent with present principles. The race car 216 is shown in greater detail in FIG. 4. As shown in this figure, the race car 216 may include a seat 400 in which a user can sit. The electronic race car may also include an electronic gas pedal 405 and an electronic brake pedal 410, either of which may be pushed forwards and released backwards by the user using his/her foot to either accelerate or decelerate/brake a virtual vehicle being controlled by the user as part of the racing simulation (via control of the real-life electronic pedals 405, 410). The pedals 405, 410 may thus include one or more sensors such as infrared (IR) proximity sensors, potentiometers, pressure sensors, position sensors, etc. to sense movement of the pedals 405, 410 to thus provide associated input to the racing simulation.

As also shown in FIG. 4, an electronic steering wheel 415 may also be included on the device 216. The steering wheel may include one or more vibrators 420 at different locations on the steering wheel 415 to create haptic/force feedback consistent with present principles. Each vibrator 420 may be established by, for example, an electric motor connected to an off-center and/or off-balanced weight via the motor’s rotatable shaft so that the shaft may rotate under control of the motor (which in turn may be controlled by a processor assembly such as the assembly 122) to create vibration of various frequencies and/or amplitudes as well as force simulations in various directions.

The steering wheel 415 may also include a potentiometer 425 or other type of sensor to sense turning of the steering wheel 415 while the user plays the racing simulation.

As also shown, the device 216 may include one or more electronic fans 430 including respective motors controllable by the device to increase and decrease the speed of the fans 420 to create wind proportional to a speed of a virtual race car being controlled by the user as part of the racing simulation to thus simulate wind that might be experienced by a real-life racer while racing. Other devices to similarly generate air flow may also be used.

The device 216 may further include a wired or wireless wearable device 440 that may be engaged with a user’s wrist or other body part to sense one or more biometrics of the user. Thus, the device 440 may include a heart rate sensor, an oxygen level sensor, a body temperature sensor, and/or another type of sensor for providing biometric input to a system operating consistent with present principles.

As also shown in FIG. 4, the device 216 may include a five-point active, electronic seatbelt with active tensioner 450 that anchors to the seat 400 at five respective locations, such as above each shoulder, to the side of each hip, and in between the legs. The active seatbelt tensioner may be another type of seatbelt tensioner as well, such as a two-point or three-point active seatbelt tensioner. Each anchor point of the seatbelt 450 may be coupled to a motorized spool in the seat 400 that forms part of the tensioner, with the spool configured to extend and retract the respective strap from that anchor point under control of a processor system consistent with present principles. Thus, each of the five straps of five-point tensioner 450 may be independently extendable via a respective spool to lengthen the strap to decrease tension of the strap against the user, and independently retractable via the respective spool to shorten the strap to increase tension of the strap against the user.

As also shown in FIG. 4, the device 216 may include a display 460 on which visual content may be presented. The visual content may include real-time video of the racing simulation as well as the GUIs described below. Note that the headset display may additionally or alternatively present the same content.

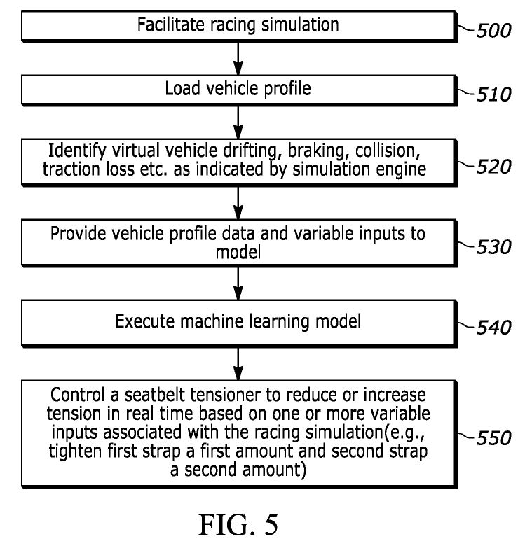

With FIGS. 1-4 having been described, it is to be understood that a user’s experience in a vehicle racing simulation may be enhanced through several operations performed by a device/system, which may include a processor system executing a set of codes to control functional elements of a real-life racing apparatus such as the e-vehicle 216. Accordingly and now referring now to FIG. 5, it shows example logic that may be executed by a device such as the system 100, headset 206, server 214, and/or electronic race car 216 alone or in any appropriate combination consistent with present principles. Note that while the logic of FIG. 5 is shown in flow chart format, other suitable logic may also be used.

Beginning at block 500, the device may facilitate (e.g., execute) a virtual racing simulation where a person/end-user races a first virtual race care (more generally, first simulation vehicle) against other virtual race cars on a virtual race track. The other race cars might be controlled by other human players/users, and/or autonomously by the simulation system itself.

But before the user’s virtual race starts, in some examples at block 510 the device may load a vehicle profile into the simulation for the particular real-world high-performance vehicle chosen by the user to race virtually in the racing simulation. Thus, it is to be understood that different sim (virtual) cars may be used that are based on different real-world high-performance vehicles whose metrics have been incorporated into the simulation so that the corresponding virtual vehicles perform similarly to the real-world counterparts (but in the virtual race). The metrics may include different braking metrics, turning ability and turning radius metrics, tire friction metrics, different throttle responsiveness metrics, vehicle acceleration and max speed metrics, etc. This data may be provided to a machine learning (ML) model as will be described in a moment.

However, the logic may first proceed from block 510 to block 520. At block 520 the device may identify one or more variable inputs to the racing simulation. In one example, physics data for the first simulation vehicle may establish the variable inputs. The physics data may be received from a simulation engine that executes the simulation. The physics data may be used to identify real-time simulation vehicle velocity, real-time tire traction (e.g., whether the vehicle is drifting), real-time terrain data for terrain underneath and around the vehicle, real-time braking data for application of the first simulation vehicle’s virtual brakes, real-time vehicle collision data (collisions with other virtual vehicles or other virtual objects around the racetrack), and other types of real-time data related to the performance of the first simulation vehicle during the virtual race.

From block 520 the logic may then proceed to block 530. At block 530 the device may provide the vehicle profile data loaded at block 510 and variable input data identified at block 520 to a model executed by (or at least accessible to) the simulation engine. Then at block 540 the device may execute the model to receive the one or more variable inputs and to generate, based on the one or more variable inputs (including the vehicle profile data), an inference indicating a configuration of the seatbelt tensioner to apply in response to an event in the racing simulation. The event might be a vehicle collision, vehicle drifting where the rear wheels of the virtual vehicle are not fully engaged with the driving surface, virtual vehicle traction loss in the racing simulation due to virtual inclement weather, etc. The inference may thus indicate different amounts of tension to apply at different straps of the active seatbelt tensioner as strapped around the user while the user sits in the seat 400 with the seatbelt 450 holding the user in place to apply tension across the chest, waist, etc.

The model that is executed may be an artificial intelligence (AI) model, such as a machine learning (ML) model in particular. The model may therefore include, in one particular non-limiting example, one or more convolutional neural networks (CNN) configured for pattern recognition based on different types of racing simulation variable inputs and vehicle profiles.

Accordingly, responsive to receiving an output from the model indicating the different amounts of tension to apply, the device may control the active seatbelt tensioner hardware in real time at block 550 to apply tension according to the model’s output. Thus, at block 550 the device may, at various points in the virtual race along a virtual route, dynamically control the seatbelt tensioner by reducing or increasing tension in one or more straps of the seatbelt tensioner.

For example, the device may dynamically reduce tension in one or more straps of the seatbelt tensioner responsive to virtual vehicle braking in the racing simulation. At various other points in the same racing simulation, the device might then dynamically increase tension in one or more straps of the seatbelt tensioner responsive to virtual vehicle acceleration in the racing simulation. The electronic seatbelt tensioner may also be controlled to tighten (retract) one or more straps on one side of the seat 400 and/or to loosen (extend) one or more straps at the other side of the seat 400 (left or right side) to help give the user the sensation of being forced to one side of the real-life device 400 or the other based on G-force/centripetal force being simulated in the racing simulation through the shortened straps on one side.

So, for example, plural straps on the left side of the user may be concurrently tightened the same or different amounts, and plural straps on the right side of the user may be concurrently loosened the same or different amounts, to simulate centripetal force pushing the user to the left. Likewise, plural straps on the right side of the user may be concurrently tightened the same or different amounts, and plural straps on the left side of the user may be concurrently loosened the same or different amounts, to simulate centripetal force pushing the user to the right. Up/down forces may also be simulated using upper and lower straps, respectively. Further note that vehicle acceleration forces may be simulated by loosening all belt straps via their anchor points (e.g., so the belt straps are not taut), while vehicle deceleration forces may be simulated by tightening all belt components straps via their anchor points (e.g., so the belt straps are taut).

However, to reiterate, note that active seatbelt tensioner may be variable based on other race metrics as well, including the vehicle profile data loaded at block 510. This might cause slight changes in strap tension outputs from the model for the same in-simulation event because the model is accounting for the particular metrics of whatever virtual high-performance racecar was chosen by the user in accordance with the description above.

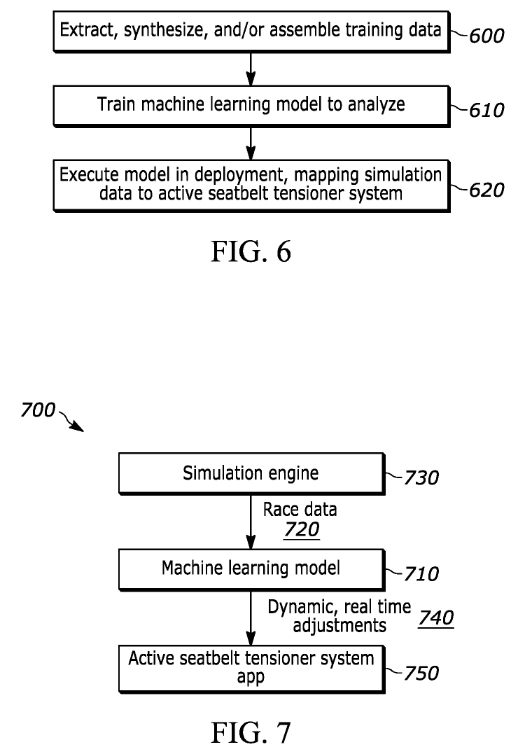

Now in reference to the example logic of FIG. 6, it is to be understood that artificial intelligence (AI)-assisted data generation and processing may be used to accurately replicate the dynamic forces experienced during real-world racing scenarios while executing a simulation race. Thus, advanced AI systems may be deployed to extract and synthesize comprehensive data from sources like real-world in-car footage, real-world telemetry logs, and real-world sensor readings. Machine learning models may be trained to analyze this multi-modal data to then identify intricate patterns and relationships between the various inputs and the corresponding forces exerted on the seatbelt straps by the user in various real-life driving situations. Thus, supervised learning, self-learning, unsupervised learning, reinforcement learning, and other deep learning techniques may be used to train the model. This extracted data can then be mapped to the active seatbelt tensioner during deployment, enabling an unparalleled degree of congruence between the virtual simulation and the experiences of real-life professional race drivers. The AI model’s ability to continuously learn and refine its inferences from an ever-expanding dataset of high-performance vehicles can also help the system remain aligned with the latest real-world conditions and vehicle dynamics.

With this understanding in mind, reference is now made to FIG. 6. At block 600, the system may extract, synthesize, and/or assemble the aforementioned training data. The dataset of training data may include ground truth tension amounts by strap along with vehicle profile data and race inputs (like events like turns, braking, acceleration, etc.) from different real-world driving scenarios. Then at block 610 the system may train the machine learning (ML) AI-based model to analyze the data and provide inferences of strap tension amounts to apply at each strap of the active seatbelt tensioner for a given event/type.

From block 610 the logic of FIG. 6 may then proceed to block 620. At block 620 the system may execute the ML model during deployment consistent with the logic of FIG. 5 and disclosure above in reference to FIG. 6. The system may thus map simulation data to an electronic race car’s adaptive active seatbelt tensioner system according to its learning from real-world race scenarios.

Continuing the detailed description in reference to FIG. 7, this figure shows example software architecture 700 that may be implemented consistent with present principles. Accordingly, note that an ML model 710 according to FIG. 6 may receive race data and vehicle profile data 720 from a simulation engine 730.

The ML model 710 may then analyze the data 720 to provide an output 740 of dynamic, real-time strap tension metrics to apply at the active seatbelt tensioner via an active seatbelt tensioner app/API 750 executing at the electronic race car.

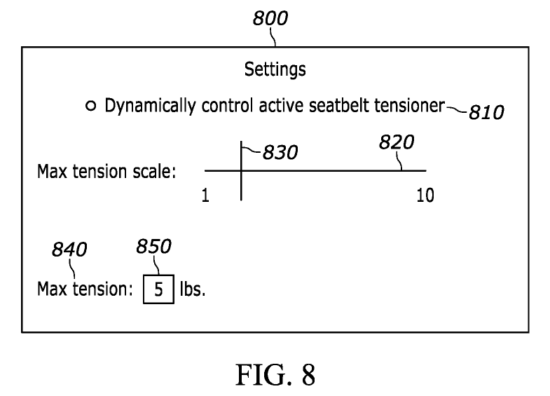

Now in reference to FIG. 8, this figure shows an example GUI 800 that may be presented on a display for an end-user to configure one or more settings of an apparatus, racing simulation app, and/or electronic racecar to operate consistent with present principles. Each option discussed below may be selected by selecting the respective radio button shown adjacent to each option, whether through cursor input, touch input, or another type of input.

As shown in FIG. 8, the GUI 800 may include an option 810 that is selectable to set or configure the device to undertake present principles. Therefore, in one example, selection of the option 810 a single time may configure the device to, for multiple future racing simulations, execute the functions described above in reference to FIGS. 5-7. The option 810 may be accompanied by one or more other controls.

For example, the GUI 800 may include a scale 820 with slider 830 so that the user can slide the slider 830 left and right along the scale 820 to decrease or increase maximum tension the active seatbelt tensioner exerts on the user from a scale of one to ten. Thus, the user may control the max tension to his/her comfort level as the user engages in the simulation more and more. The GUI 800 may also include a setting 840 at which the user can enter a max tension in the form of a particular number of max pounds of force to apply (by directing numerical input to input box 850).

It may now be appreciated that racing simulations consistent with present principles provide realistic feedback in sim racing, providing a tactile experience that accurately mimics the physical sensations of real-world racecar driving, including the effects of inertia and g-forces experienced during driving. Thus active seatbelt tensioners may be used consistent with present principles to reflect the dynamic changes in tension experienced in a real race car. This in turn may increase the overall realism and immersion of the simulation, with the tensioner adapting to different racing conditions such as cornering, accelerating, or braking to mimic the subtle changes in g-forces that affect a driver’s body through the seat belt during real world driving.

Components included in one embodiment can be used in other embodiments in any appropriate combination. For example, any of the various components described herein and/or depicted in the Figures may be combined, interchanged or excluded from other embodiments.

It is to be understood that whilst present principals have been described with reference to some example embodiments, these are not intended to be limiting, and that various alternative arrangements may be used to implement the subject matter claimed herein. Accordingly, while particular techniques and devices are herein shown and described in detail, it is to be understood that the subject matter which is encompassed by the present application is limited only by the claims.

What is claimed is:

1. A device, comprising:
a processor system; and
storage accessible to the processor system and comprising instructions executable by the processor system to:
facilitate a racing simulation;
as part of facilitating the racing simulation, control a seatbelt tensioner in real time as the racing simulation transpires, the seatbelt tensioner controlled in real time based on one or more variable inputs associated with the racing simulation.

2. The device of claim 1, wherein the seatbelt tensioner comprises a five-point seatbelt tensioner, the seatbelt tensioner couplable to a seat of an electronic race car at five different locations on the seat.

3. The device of claim 2, comprising the seatbelt tensioner and seat.

4. The device of claim 3, comprising the electronic race car.

5. The device of claim 1, wherein the instructions are executable to:
as part of facilitating the racing simulation, control the seatbelt tensioner to tighten a first strap of the seatbelt tensioner a first amount and to concurrently tighten a second strap of the seatbelt tensioner a second amount, the first strap being different from the second strap.

6. The device of claim 5, wherein the first amount is different from the second amount.

7. The device of claim 5, wherein the instructions are executable to:
execute a model to receive the one or more variable inputs and to generate, based on the one or more variable inputs, an inference indicating the first amount and the second amount.

8. The device of claim 6, wherein a first variable input of the one or more variable inputs relates to virtual vehicle drifting in the racing simulation.

9. The device of claim 6, wherein a first variable input of the one or more variable inputs relates to virtual vehicle braking in the racing simulation.

10. The device of claim 6, wherein a first variable input of the one or more variable inputs relates to a virtual vehicle collision in the racing simulation.

11. The device of claim 6, wherein a first variable input of the one or more variable inputs relates to virtual vehicle traction loss in the racing simulation due to virtual inclement weather.

12. The device of claim 6, wherein the one or more variable inputs are provided by a simulation engine that executes the racing simulation.

13. A method, comprising:
facilitating a racing simulation;
as part of facilitating the racing simulation, dynamically controlling a seatbelt tensioner as the racing simulation transpires, the seatbelt tensioner dynamically controlled based on one or more variable inputs associated with the racing simulation.

14. The method of claim 13, comprising:
dynamically controlling the seatbelt tensioner by reducing tension in one or more straps of the seatbelt tensioner responsive to virtual vehicle braking in the racing simulation.

15. The method of claim 13, comprising:
dynamically controlling the seatbelt tensioner by increasing tension in one or more straps of the seatbelt tensioner responsive to virtual vehicle acceleration in the racing simulation.

16. The method of claim 13, comprising:
executing a model to receive the one or more variable inputs and to generate, based on the one or more variable inputs, an inference indicating a configuration of the seatbelt tensioner to apply in response to an event in the racing simulation.

17. At least one computer readable storage medium (CRSM) that is not a transitory signal, the at least one CRSM comprising instructions executable by a processor system to:
facilitate a racing simulation;
as part of facilitating the racing simulation, control a seatbelt tensioner in real time as the racing simulation transpires, the seatbelt tensioner controlled in real time based on one or more inputs associated with the racing simulation.

18. The at least one CRSM of claim 17, wherein the instructions are executable to:
execute a model to receive the one or more inputs and to generate, based on the one or more inputs, an inference indicating a configuration of the seatbelt tensioner to apply in response to an event in the racing simulation.

19. The at least one CRSM of claim 18, wherein the model is an artificial intelligence (AI) model.

20. The at least one CRSM of claim 18, wherein the configuration of the seatbelt tensioner comprises a left-side strap of the seatbelt tensioner being shorter than a right-side strap of the seatbelt tensioner.
